(19) United States
(12) Patent Application Publication
(10) Pub. No.: US 2026/0221556 A1
(43) Pub. Date: Jul. 30, 2026

(54) STEEL SHEET FOR TOP COVER OF BATTERY PACK AND ITS MANUFACTURING METHOD

(71) Applicant: ArcelorMittal, Luxembourg (LU)

(72) Inventors: Tarek KRIM, Metz (FR); Pascale SANZEY, Laquenexy (FR)

(21) Appl. No.: 19/147,734

(22) PCT Filed: Jan. 19, 2024
(86) PCT No.: PCT/IB2024/050527

§ 371 Date: Jul. 14, 2025

(30) Foreign Application Priority Data
Jan. 30, 2023 (WO) PCT/IB2023/050784

(51) Int. Cl. H01M 50/164; B32B 15/01; H01M 50/159; H01M 50/16

(52) U.S. Cl. CPC H01M 50/164; B32B 15/013; H01M 50/159; H01M 50/16; B32B 2311/20; B32B 2311/30; H01M 2220/20

(57) ABSTRACT

Top cover of a battery pack including a metallic coated steel sheet covered on both sides by an organic coating, wherein the organic coating is thinner on the inner side of the battery pack than on the outer side of the battery pack.

The present invention deals with the housing elements of a battery in the car industry. More specifically it relates to a top cover of a battery pack of an electric or hybrid vehicle having good resistance to fire exposure.

### BACKGROUND

Electrical vehicles or hybrid vehicles have to embed at least one heavy and bulky battery pack. This battery pack is made of a plurality of battery modules, each module containing battery cells. Said battery pack must be very well protected against thermal loads that may occur in case of accident, fire or any exposure to high temperature during the assembly or the further life of the vehicle.

### SUMMARY OF THE INVENTION

A current trend is to have bigger and bigger modules and to store all the battery cells into a battery pack housing while leaving the intermediary containment into modules. The internal architecture of the battery pack can be composed of cells grouped into modules or made of a container directly including the battery cells closed by a lid. Whatever the internal architecture of the battery pack, it is closed on its top face by an upper cover.

As depicted on FIG. 1, a battery pack comprises from the bottom to the top:
A shield element 1;
an external frame 2, containing an internal architecture of the battery pack including battery cells, and reinforcement parts optionally battery modules; and
an upper cover also named top cover 3.

The top cover may be adhesively bonded and/or screwed together with other parts of the battery pack. It may also be connected to the internal architecture by any method of assembly such as welding.

Top covers can be made of aluminum sheets, for instance out of a 6000-series aluminum alloy and possibly from the specific AL 6016 alloy.

Top covers can also be made of galvanized steel sheets.

Fire hazards related to batteries is a major aspect regarding the safety in electric or hybrid vehicles. Especially the thermal runaway, once started in one battery cell produces enough heat to cause adjacent cells to also go into thermal runaway. This produces a fire that repeatedly flares up as each battery cell heats up, breaks, may explode and releases its content. The chemicals inside the battery heat up, which causes further degradation of any enclosures, be it the enclosure of cells, of the modules or of the whole battery pack. The flammable electrolyte can ignite or even explode when exposed to the oxygen in the air.

The top cover of the battery pack being the first separation between the battery cells and the passenger compartment, it is of major importance for fire resistance of battery packs. Top covers must ensure a safe separation between the battery pack and the passenger compartment even at high temperature. For this reason, the top cover must maintain its physical integrity along the life of the vehicle. Therefore, the protection of the top cover must also prevent corrosion from the outside atmosphere of the battery pack.

The top cover must also release few or no gas when submitted to high temperatures. Especially gases like CO or CO2 or other vaporous combustion products may tremendously increase the pressure inside the battery pack when they are released inside the pack and heated by fire. This may induce opening of the pack, cracks through the housing and explosion.

The patent application US2019/0131602 discloses a housing for battery pack with a top cover. This cover plate is configured as a sandwich comprising at least a metal portion and a plastic portion, wherein the metal portion is manufactured from at least one of steel and aluminum.

It is an object of the present invention to provide a top cover that has outstanding resistance to fire exposure, including risks of explosion, along the vehicle life.

The present invention provides a top cover of a battery pack comprising a metallic coated steel sheet covered on both sides by an organic coating, wherein said organic coating is thinner on the inner side of the battery pack than on the outer side of said battery pack.

The present invention also provides a battery pack including a top cover as described above.

### BRIEF DESCRIPTION OF THE DRAWINGS

Other characteristics and advantages of the present invention will become apparent from the following detailed description of the invention.

To illustrate the invention, various embodiments and trials of non-limiting examples will be described, particularly with reference to the following figures:

FIG. 1 illustrates a battery pack and its top cover in an electric battery vehicle,

FIG. 2 illustrates a top cover according to the invention after fire exposure during 130 seconds at a temperature of 1300° C., and

FIG. 3 illustrates a top cover not according to the invention after fire exposure during 130 seconds at 1300° C.

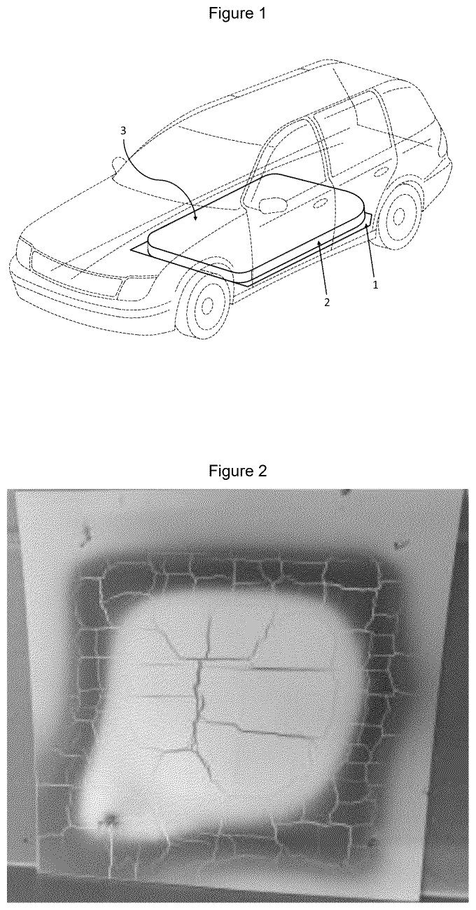

### DETAILED DESCRIPTION

The present invention relates to a top cover for a battery pack comprising a metallic coated steel sheet wherein said metallic coating is topped by an organic coating.

For this purpose, any steel can be used in the frame of the invention. Preferably, steels having a good formability are well suited. For example, the top cover can be made of mild steel for deep drawing such as Interstitial Free steel having the following weight composition: C≤0.01%; Si≤0.3%; Mn≤1.0%; P≤0.1%; S≤0.025; Al≥0.01%; Ti≤0.12%; Nb≤0.08%; Cu≤0.2%.

For example, the top cover can be made of High Strength Low Alloy (HSLA) steel having the following weight composition: C≤0.1%; Si≤0.5%; Mn≤1.4%; P≤0.04%; S≤0.025%; Al≥0.01%; Ti≤0.15%; Nb≤0.09%; Cu≤0.2%.

The steel sheet can be obtained by hot rolling of a steel slab and subsequent cold rolling of the obtained steel coil, depending on the desired thickness, which can be for example from 0.6 to 1.4 mm, preferably from 0.7 to 1.2 mm.

The steel sheet is then coated with a metallic coating by any coating process. For example, the steel sheet is hot dip coated in a molten bath and subsequently wiped by air knives. Advantageously, the molten bath is based on zinc and comprises unavoidable impurities.

In a preferred embodiment, the metallic coating comprises, by weight, from 4.0 to 5.0% of aluminum, from 0.2 to 0.6% of magnesium, the balance being zinc and unavoidable impurities coming from the manufacturing process up to 0.2%. Such a coating comprising aluminum and magnesium increases the corrosion resistance.

In another preferred embodiment, metallic coating comprises, by weight, from 4.4 to 5.6% of aluminum, from 0.3 to 0.56% of magnesium, optionally up to 0.2% tin, the remainder of the metallic coating being exclusively zinc, unavoidable impurities resulting from the process and optionally one or more additional elements selected from the group consisting of Si, Ti, Ca, Mn, La, Ce and Bi, wherein the content by weight of each additional element in the metallic coating is less than 0.3%, wherein the presence of nickel is excluded.

Optionally, the coating comprises, by weight, up to 0.2% tin, preferably up to 0.1%, advantageously up to 0.035% tin.

Optionally, the coating comprises up to 3.0% weight iron, when the coating is applied by hot dip coating. Iron comes from the dissolution of the steel sheet in the hot dip coating bath and can vary during production.

The metallic coating weight can be of 60 to 120 g/m² in total on both sides or less. Preferably, the coating weights from 80 to 100 g/m². For example, the metallic coating thickness of the top cover is from 5 to 15 μm per side.

After metallic coating, the steel sheet is covered by an organic coating, for example on an organic coating line. The surface can be prepared by a degreasing step and a subsequent conversion treatment applied by roll coat to ensure the grip of the layer of organic coating.

The metallic coated steel sheet according to the invention is coated on both sides with one or two layers of organic coating.

The organic coating can be applied by roll-coat. The organic coating is then baked in an oven. The thickness of the organic layer in the following is meant after baking.

The organic coating covering the top cover according to the invention is thinner on the inner side of the battery pack than on the outer side of the battery pack. The person having ordinary skill in the art will be able to determine the suitable organic coating thickness depending on the specific architecture of the battery pack and of the vehicle.

The inner atmosphere of the battery pack is sealed and not corrosive. It remains unchanged during vehicle life. There is no risk of atmospheric corrosion of the top cover on the inner side of the battery pack.

When the battery pack is made of aluminum, galvanic coupling can occur with the top cover made of steel in contact with aluminum. Due to said galvanic coupling, corrosion of aluminum occurs. The contact must be avoided by a layer of organic coating.

In case of fire or high temperatures, the coating shall not increase the pressure inside the battery pack. The combustion of the organic coating may release gas depending on its composition and thickness.

Preferably, the organic coating covering the top cover on the inner side of the battery pack has a thickness from 4 to 20 μm. The inventors have found that, if the organic coating is thinner than 4 μm, it may be too thin to prevent contact with aluminum and galvanic coupling. If the organic coating is thicker than 20 μm, its combustion in case of fire may release fumes and gases increasing the pressure inside the battery pack.

More preferably the organic coating covering the top cover on the inner side of the battery pack has a thickness from 4 to 15 μm, or even from 4 to 10 μm.

In a preferred embodiment, the organic coating covering the top cover on the inner side of the battery pack has one single layer of 4 to 6 μm in contact with the metallic coating.

In another preferred embodiment, the organic coating covering the top cover on the inner side of the battery pack is deposited in two layers and has a first layer of 3 to 5 μm in contact with the metallic coating, and a second layer of 6 to 15 μm in contact with the first layer.

The outer side of the battery pack, especially the outer side of the top cover may be exposed to the exterior air, moisture, dust, and possibly other elements coming from the road. The coating according to the invention also provides corrosion protection of the top cover against the atmosphere outside the battery pack during vehicle life.

Preferably, the organic coating covering the top cover on the outer side of the battery is deposited in two layer and has a total thickness from 22 to 55 μm.

In a preferred embodiment, the organic coating covering the top cover on the outer side of the battery pack has a first layer of 4 to 6 μm in contact with the metallic coating, and a second layer of 18 to 20 μm in contact with the first layer.

In another embodiment, the organic coating on the outer side of the battery pack has a first layer of 10 to 25 μm in contact with the metallic coating, and a second layer of 15 to 30 μm in contact with the first layer.

The metallic and organic coated steel sheet can then be cut into a blank. The blank can be formed by press stamping to the specific shape of the top cover.

The invention will now be illustrated by examples which are not limiting.

### EXAMPLES

In order to determine the resistance to fire of the top covers, several tests were performed. All tests were performed on the same test device.

The test device was adapted from the test device described in the Standard ISO 2685:1998. Both of the following adaptations were done: Firstly, the sample was thermally isolated from the structure of the test device by a 10 mm thick plate of calcium silicate. Secondly, the gas burner generating the flame has been calibrated to achieve the targeted temperature on the face of the sample that is exposed to the flame.

For all tests, the samples have the same dimension of 150×150 mm². Each sample is positioned in front of the gas burner to get hit by the flame. The plate between the sample and the burner has an opening area with the dimension of 90×90 mm².

The flame simulated a fire inside the battery pack. According to the invention, the side with the thinnest organic coating is exposed to the flame.

Three materials were tested:
material 1 is a 0.7 mm thick steel sheet. It is hot-dip metallic coated. The metallic coating contains 5.0 wt % aluminum and 0.5 wt % magnesium, the balance being zinc. The metallic coating weight is 120 g/m² in total for both sides. Material 1 is also organic coated. On the face exposed to the flame, it is coated with one layer of 5 μm in contact with the metallic coating. On the face NOT exposed to the flame, the organic coating is as follows: a 5 μm thick first layer in contact with the metallic coating and a 20 μm thick second layer in contact with the first layer.
material 2 is a 1.0 mm thick aluminum sheet of 6016 series.
material 3 is a 0.8 mm galvanized steel sheet coated with e-coat. The hot-dip coating contains 0.2% of aluminum by weight, the remainder being zinc. The metallic coating weight is 140 g/m². After a phosphating step, the sample was dipped in an e-coating bath. The e-coat tested is Powercron® 6200 HE from supplier PPG. The dry thickness of organic coating after baking is 25 μm on each face.
material 4 is a 0.7 mm thick steel sheet. It is hot-dip galvanized. The metallic coating comprises up to 0.2 wt % Aluminum, the remainder being zinc. The metallic coating weight is 275 g/m in total for both sides. On the face exposed to the flame, the organic coating is as follows: a 4 μm thick first layer in contact with the metallic coating and a 8 μm thick second layer in contact with the first layer. On the face NOT exposed to the flame, the organic coating is as follows: a 5 μm thick first layer in contact with the metallic coating and a 20 μm thick second layer in contact with the first layer.

In the following, sample 1 is made of material 1, sample 2 is made of material 2 and sample 3 is made of material 3.

All samples were exposed to the same fire test: the flame temperature is 1300° C. and the exposure time is 130 seconds.

Several criteria are considered for analysis of the tests. The integrity of the sheet, i. e. whether the flame has pierced the sheet or not and the temperature of the face unexposed to the flame at the end of the test.

The presence of bubbles in the coating after the test. The presence of a bubble indicates the release of gas.

TABLE 1
Flame exposure: 130 s at 1300° C.

| | | Organic | Organic | | | |
|---|---|---|---|---|---|---|
| | | coating on | coating on | | Temperature | |
| | | side exposed | side NOT | | of the | |
| Flamme | Sample | to the flame | exposed to | Flame | sample after | Presence of |
| Exposure | Nr | (μm) | the flame(μm) | Piercing | 130 s | bubbles |
| 1300° C. | 1* | 5 | 25 | No | 640° C. | No |
| 130 s | 2 | 0 | 0 | Yes after 45 s | above | No |
| | | | | | 910° C. | |
| | 3 | 25 | 25 | No | 610° C. | Yes |
| | 4* | 12 | 35 | No | 743° C. | No |

*trial according to the invention

Underlined values are not according to the invention.

After an exposure 1300° C. for 130 seconds, the back-face of samples 1 and 3 made of steel remains at a temperature of less than 750° C. and doesn't show any signs of melting. On the contrary, the flame has pierced material 2 made of thicker aluminum.

Sample 1 and 4, according to the invention, doesn't show any bubbles as can be seen on FIG. 2. FIG. 2 only shows cracks that come from different thermal expansions between the steel sheet and organic coating layer.

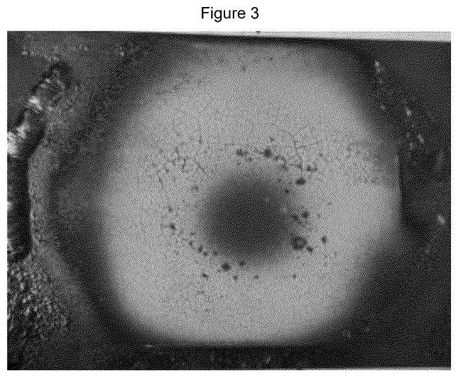

Sample 3, which has the same organic coating thickness on the inner and on the outer side, presents black dots, as can be seen on FIG. 3. These are bubbles which have released combustion products of the organic coating in form of gas.

1-8. (canceled)

9. A top cover of a battery pack comprising:
a metallic coated steel sheet covered on an inner side of the battery pack and an outer side side of the battery pack by an organic coating, wherein the organic coating is thinner on the inner side than on the outer side.

10. The top cover as recited in claim 9 wherein the metallic coating comprises, by weight, from 4.0 to 5.0% of aluminum, a balance being zinc and unavoidable impurities coming from processing up to 0.2%.

11. The top cover as recited in claim 9 wherein the organic coating on the inner side of the battery pack has a thickness from 4 to 20 μm.

12. The top cover as recited in claim 9 wherein the organic coating on the outer side of the battery pack has a thickness from 22 to 55 μm.

13. The top cover as recited in claim 9 wherein the organic coating on the outer side of the battery pack has two layers.

14. The top cover as recited in claim 9 wherein the organic coating on the inner side of the battery pack has one single layer.

15. The top cover as recited in claim 9 wherein the organic coating on the inner side of the battery pack has two layers.

16. A battery pack comprising the top cover as recited in claim 9.
